(19) United States
(12) Patent Application Publication
(10) Pub. No.: US 2012/0146954 A1
(43) Pub. Date: Jun. 14, 2012

(54) OPTICAL TOUCH SCREEN PANEL

(75) Inventors: Suntak PARK, Daejeon (KR); Seung Koo Park, Daejeon (KR); Jung Jin Ju, Daejeon (KR); Min-su Kim, Daejeon (KR); Jin Tae Kim, Daejeon (KR); Ki Uk Kyung, Daejeon (KR)

(73) Assignee: ELECTRONICS AND TELECOMMUNICATIONS RESEARCH INSTITUTE, Daejeon (KR)

(21) Appl. No.: 13/301,813

(22) Filed: Nov. 22, 2011

(30) Foreign Application Priority Data
Dec. 14, 2010 (KR) 10-2010-0127694

(51) Int. Cl. G06F 3/042

(52) U.S. Cl. 345/175

(57) ABSTRACT

Disclosed is an optical touch screen panel including: a light source unit to generate light parallel with a horizontal axis or a vertical axis of a touch screen; a first beam deflector to increase the width of the light parallel with the horizontal axis to be matched with the width of the horizontal-axis of the touch screen, or increase the width of the parallel light parallel with the vertical axis to be matched with the width of the vertical-axis of the touch screen in order to reflect the parallel light having the increased width; a second beam deflector to reduce the width of the parallel light incident from the first beam deflector in order to reflect the parallel light having the reduced width; and a photodetector unit to sense a touched position of an object on the horizontal-axis or the vertical-axis of the touch screen.

### CROSS-REFERENCE TO RELATED APPLICATIONS

This application is based on and claims priority from Korean Patent Application No. 10-2010-0127694, filed on Dec. 14, 2010, with the Korean Intellectual Property Office, the disclosure of which is incorporated herein in its entirety by reference.

### TECHNICAL FIELD

The present disclosure relates to an optical touch screen panel, and more particularly, to an optical touch screen panel capable of minimizing the number of light emitting elements and light receiving elements while minimizing the size of a panel by sensing touched positions using a beam deflector and a photodetector array.

### BACKGROUND

Generally, a touch screen panel implies an input device capable of recognizing touched positions when touching a screen by fingers or objects, without using a keyboard or a mouse.

Touch screen panels have been widely used for various fields such as banks, public offices, various medical equipments, a guiding tool for tourist information and major institutions. In particular, touch screen panels have been used in various application fields such as for personal digital assistants (PDAs), mobile phones, smart phones, iPads, and electronic books. Moreover, the application fields and functions of touch screens have gradually expanded.

From now on, it is expected that a demand for a large and inexpensive touch screen panel to apply to various high-tech products such as a large monitor and a smart TV will be increased.

A touch screen may be mainly classified into a resistive type, a capacitive type, an ultrasonic type, and an infrared type according to an implementation type.

The resistive type is a structure in which two sheets of substrates each coated with a transparent electrode are bonded together. The resistive type detects a position to which external pressure is applied when two substrates are contacted and conducted. However, since the resistive type uses two sheets of substrates for electrodes, the transmittance tends to be degraded.

The capacitive type is driven by sensing the static electricity generated from a human body. While the capacitive type has excellent functions such as a multi touch, it does not recognize the contact position when an insulated object is touched. In addition, since the capacitive type uses a high-quality transparent electrode plate, costs are increased and it is difficult to implement a large touch screen.

The ultrasonic type utilizes ultrasonic waves passing over a touch screen panel and detects the reduced signals when the screen is being touched and some of ultrasonic waves are absorbed, thereby detecting the contact position. However, the ultrasonic type is difficult to implement a small touch screen.

Since the infrared type does not use a film for a touch recognition in principle, it has transmittance of 100%, and does not lead to reflection, degradation in luminance, or spreading of a display on the screen.

Meanwhile, since maintaining of transmittance and luminance is an important factor to the quality of the screen display, the infrared type is suitable for implementing a high-quality display. Moreover, the coordinate detection type of a contact position in the infrared type does not utilize a physical contact or an electrical contact, and does not apply a load to a sensor. As a result, the infrared type has various advantages such as a high reliability and large durability, and may recognize almost all the objects such as human fingers, pens, or the like.

FIG. 1 is a diagram showing the structure of an optical touch screen panel that uses infrared light emitting elements, according to the related art.

Referring to FIG. 1, the optical touch screen panel according to the related art is configured to include a light source array 100 including a light emitting element to generate infrared rays and a photodetector array 110 disposed to be opposite or parallel with a touch screen 130 and a light source array 100, and including a light receiving element.

As shown in FIG. 1, in order to detect a two-dimensional coordinate of the touched position in touch screen 130, two pairs of light source arrays 100 and photodetector arrays 110 are necessary each disposed on a horizontal axis and a vertical axis of touch screen 130, respectively.

When a user contacts a finger or an object to touch screen 130 where infrared rays generated from light source array 100 pass over, some of the infrared rays are blocked by the finger or the object, and relevant portion of photodetectors may not receive the infrared rays. The principle of the optical touch screen panel is to detect the coordinate of a position in which the touch contact is generated by sensing the position of the photodetector that does not sense infrared rays.

In FIG. 1, the optical detector, which does not sense the infrared signals among photodetector arrays 110, is represented as a signal sensing photodetector 120.

The optical touch screen panel according to the related art includes a plurality of light emitting elements and a plurality of light receiving elements to detect touched positions. For example, 40-inch screen needs 100 or more light emitting elements and 100 or more light receiving elements corresponding to the light emitting elements.

As described above, since the optical touch screen panel according to the related art uses a plurality of light emitting elements and a plurality of light receiving elements, it is inevitable that the manufacturing costs are increased, the assembly is inconvenient, and the volume is increased. In particular, when the optical touch screen panel according to the related art is applied to the high-quality large screen, the above-mentioned problems become more serious to cause the degradation in competitiveness.

### SUMMARY

The present disclosure has been made in an effort to provide an optical touch screen panel capable of sensing touched positions by using a beam deflector and a photodetector array, instead of using a plurality of light emitting elements and a plurality of light receiving elements.

Further, the present disclosure has been made in an effort to provide an optical touch screen panel capable of remarkably reducing the number of light emitting elements and light receiving elements, and minimizing the volume of a touch screen panel.

An exemplary embodiment of the present disclosure provides an optical touch screen panel, including: a light source unit to generate light parallel with a horizontal axis or a vertical axis of a touch screen; a first beam deflector to increase the width of the incident parallel light parallel with the horizontal axis incident from the light source unit to be matched with the width of the horizontal-axis of the touch screen, or increase the width of the incident parallel light parallel with the vertical axis to be matched with the width of the vertical-axis of the touch screen in order to reflect the parallel light; a second beam deflector to reduce the width of the parallel light incident from the first beam deflector in order to reflect the parallel light having the reduced width; and a photodetector unit to sense a touched position of an object on the horizontal-axis or vertical-axis of the touch screen through the signal detection of the parallel light incident from the second beam deflector.

Another exemplary embodiment of the present disclosure provides a method of detecting the position of an optical touch, including: generating light parallel with a horizontal axis or a vertical axis of a touch screen; first reflecting parallel light to increase the width of the parallel light parallel with the horizontal axis to be matched with the width of the horizontal-axis touch screen or increase the width of the parallel light parallel with the vertical axis to be matched with the width of the vertical-axis of the touch screen in order to reflect the parallel light having the increased width; second reflecting parallel light to reduce the width of reflected parallel light in order to reflect the parallel light having the reduced width; and sensing a touched position of an object on the horizontal-axis or vertical-axis of the touch screen by detecting the signal of the reflected parallel light from the second reflecting parallel light.

According to the exemplary embodiments of the present disclosure, touched positions may be sensed by using the beam deflector and the photodetector array instead of using a plurality of light emitting elements and a plurality of light receiving elements, such that the manufacturing costs may be remarkably reduced and the volume of the panel can be minimized as compared to those of the related art.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a schematic configuration of an optical touch screen panel according to the related art.

FIG. 2 is a diagram showing a schematic configuration of an optical touch screen panel according to an exemplary embodiment of the present disclosure.

FIGS. 3A and 3B are diagrams for explaining beam reflection characteristics of a general mirror and a beam deflector.

FIGS. 4A and 4B are diagrams for explaining beam reflection characteristics of a beam deflector formed with a diffraction grating.

FIG. 5 is a diagram for explaining beam reflection characteristics of a beam deflector formed with a micro prism.

FIGS. 6A and 6B are diagrams for explaining a case in which a light source unit and a photodetector unit are vertically positioned to the beam deflector.

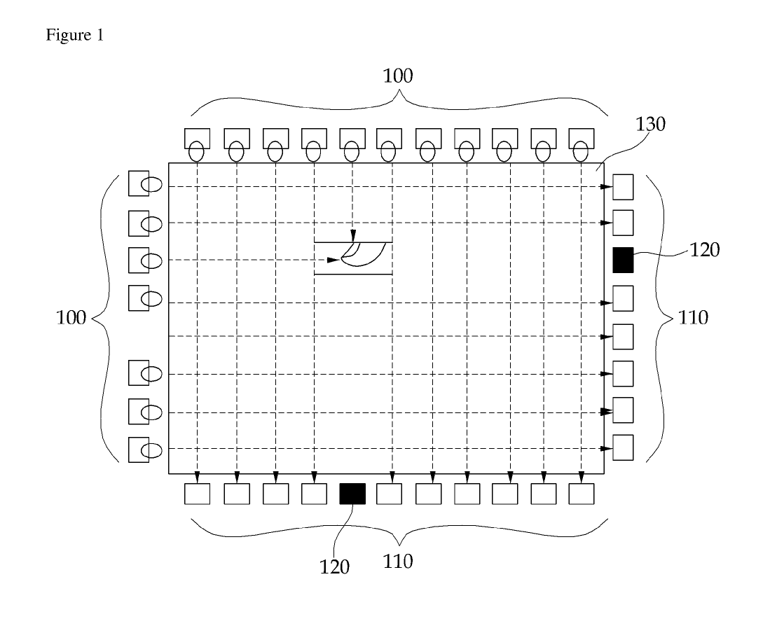

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

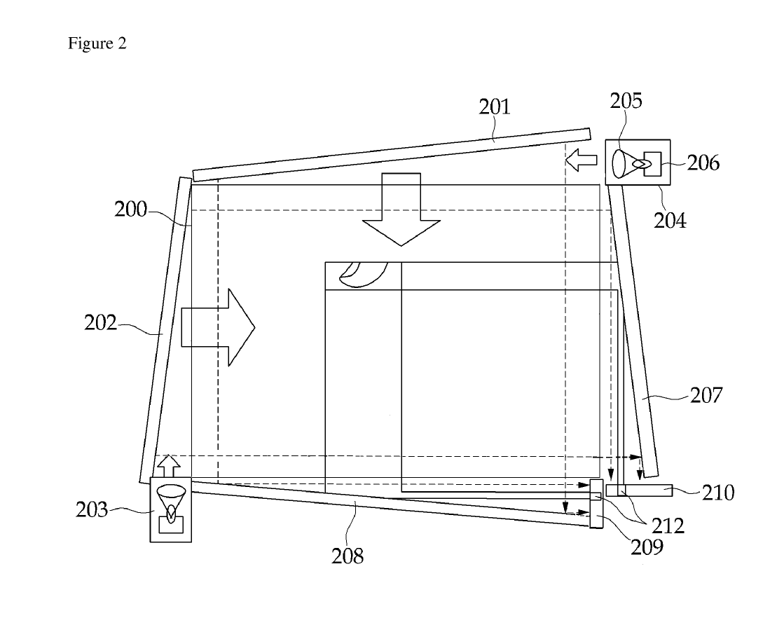

FIG. 2 is a diagram showing a schematic configuration of an optical touch screen panel according to an exemplary embodiment of the present disclosure.

The optical touch screen panel shown in FIG. 2 is configured to include a touch screen 200, light source units 203 and 204, first beam deflectors 201 and 202, second beam deflectors 207 and 208, and photodetectors 209 and 210.

Light source units 203 and 204 may be configured to include at least one light source 206 (for example, light emitting diode or laser diode) to generate beam, that is the light, and a lens 205 to generate the generated light as a parallel light.

When viewed from the figure, light source units 203 and 204 are disposed on a horizontal axis or a vertical axis of touch screen 200 to generate the parallel light parallel with the horizontal-axis direction or the vertical-axis direction. In the exemplary embodiment of the present disclosure, light source unit 204 generates light parallel with the horizontal axis of touch screen 200 and light source unit 203 generates light parallel with the vertical axis of the touch screen 200.

First beam deflector 201 is disposed side by side in parallel with light source unit 204 along the horizontal-axis direction of touch screen 200. When the parallel light parallel with the horizontal-axis direction of touch screen 200 is incident from light source unit 204, first beam deflector 201 increases the width of the incident parallel light to be matched with the width of horizontal-axis touch screen 200 to reflect the incident parallel light in a direction perpendicular to the horizontal direction, that is, in a vertical direction.

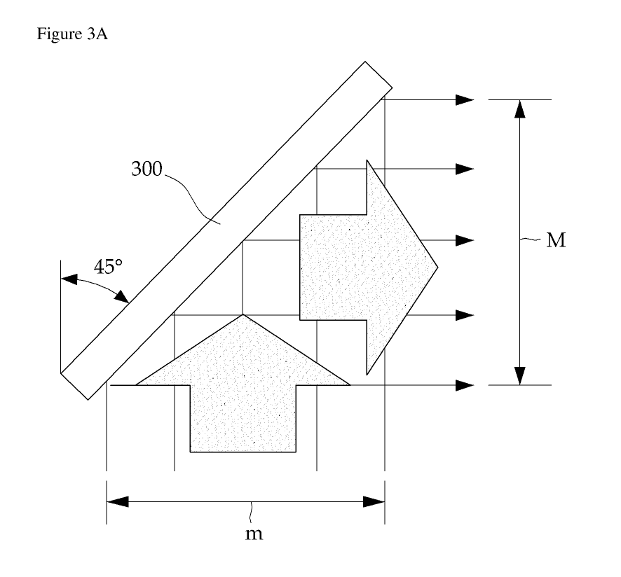

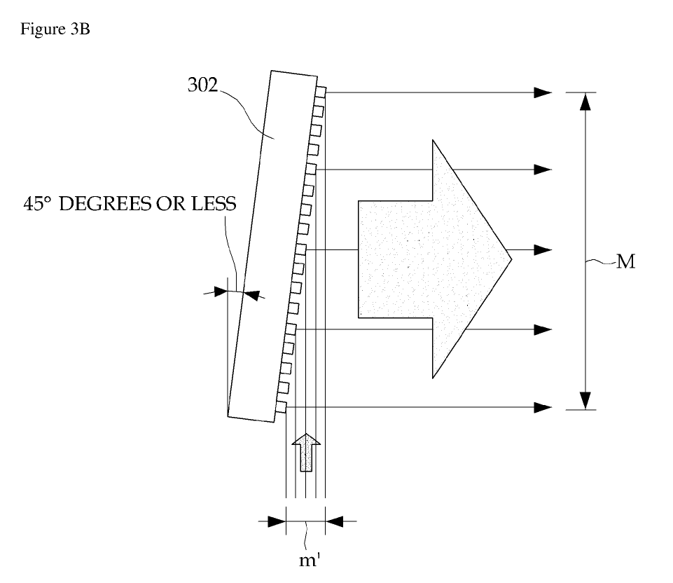

FIGS. 3A and 3B are diagrams for explaining beam reflection characteristics of a general mirror and a beam deflector.

FIG. 3A shows a case when a beam generated from a light source is reflected from a general mirror 300. In this case, the incident angle of the beam incident to the mirror is the same as the reflected angle, and the width m of the incident beam is the same as the width M of the reflected beam (m=M). Therefore, in order to reflect the incident beam at a right angle, the mirror is inclined at 45 degrees.

However, as shown in FIG. 3B, when a beam is reflected from a beam deflector 302, the incident angle is not the same as the reflected angle and the width m′ of the incident beam is different from the width M of the reflected beam.

That is, the first beam deflector uses a principle in which the width of the reflected beam is larger than the width of the incident beam (M/m′>1).

To the contrary, the second beam deflector uses a principle in which the width of beam is smaller when the incident beam and the reflected beam are changed each other.

In addition, in order to reflect the incident beam at a right angle, as shown in FIG. 3B, beam deflector 302 is positioned to be inclined at 45 degrees or less, which is an important factor capable of minimizing the volume of the touch screen panel.

Second beam deflector 208 is disposed side by side in parallel with photodetector 209 along the horizontal-axis direction of touch screen 200 so that second beam deflector 208 is positioned to be opposite to first beam deflector 201. When the parallel light having an increased width to be matched with the width of the horizontal axis of the touch screen 200 is incident in a vertical direction from first beam deflector 201, second beam deflector 208 reduces the width of the incident parallel light to the width of the parallel light incident to first beam deflector 201 from light source unit 204 to reflect the parallel light having the reduced width in a direction perpendicular to the vertical direction, that is, in a horizontal direction.

The parallel light reflected from second beam deflector 208 is transferred to photodetector 209. Photodetector 209 may detect the touched position of the horizontal axis (for example, an x-axis among two-dimensional x and y-axes) through the signal detection of the incident parallel light. In FIG. 2, a signal sensing photodetector 212 detects the touched position of the horizontal axis or the vertical axis.

Photodetectors 209 and 210 are disposed to be opposite to light source units 203 and 204, and may be configured as at least one one-dimensional or two-dimensional photo detector array.

Signal sensing photodetector 212 may be implemented as a charge coupled device (CCD) sensor or a complementary metal oxide semiconductor (CMOS) sensor to convert optical signals into electrical signals.

When photodetectors 209 and 210 are configured as the two-dimensional photodetector array, the detectors may sense a position as touched when an object is positioned at a distance close to the corresponding position even though the object is not touched on touch screen 200.

First beam deflector 202 is disposed side by side in parallel with light source unit 203 along the vertical-axis direction. When the light parallel with the vertical-axis direction of touch screen 200 is incident from light source unit 203, first beam deflector 202 increases the width of the incident parallel light to be matched with the width of vertical-axis of touch screen 200 to reflect the incident parallel light in a direction perpendicular to the vertical direction, that is, in a horizontal direction.

Second beam deflector 207 is disposed side by side in parallel with photodetector 212 along the horizontal-axis direction of touch screen 200 so that second beam deflector 207 is positioned to be opposite to first beam deflector 202. When the parallel light having an increased width to be matched with the width of the vertical axis of touch screen 200 is incident in a horizontal direction from first beam deflector 202, second beam deflector 207 reduces the width of the incident parallel light to the width of the parallel light incident to first beam deflector 202 from light source unit 203 to reflect the parallel light having the reduced width in a direction perpendicular to the horizontal direction, that is, in a vertical direction.

The parallel light reflected from second beam deflector 207 is transferred to photodetector 210 and photodetector 210 may sense the touched positions of the vertical axis (for example, a y-axis among two-dimensional x and y-axes) through the signal detection of the incident parallel light.

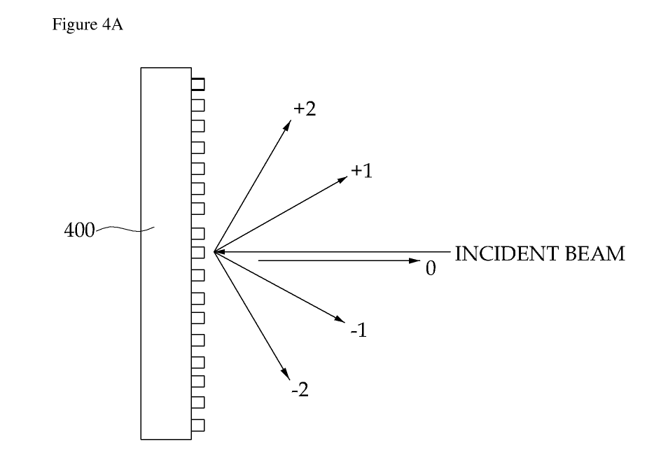

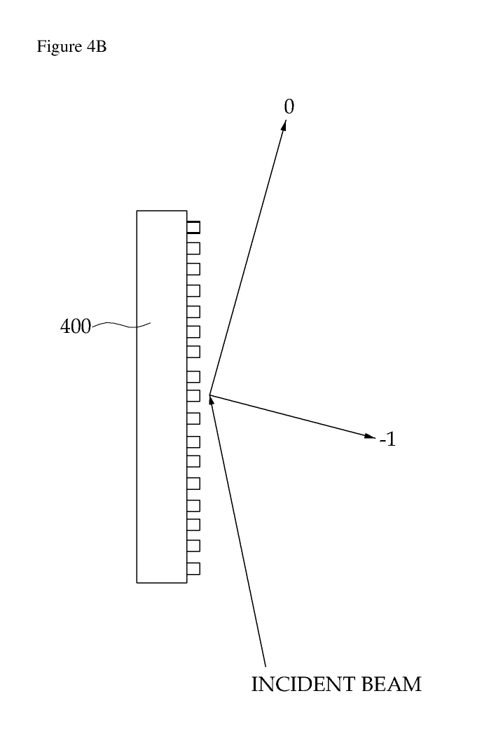

FIGS. 4A and 4B are diagrams for explaining beam reflection characteristics of a beam deflector formed with a diffraction grating.

Referring to FIGS. 4A and 4B, the beam deflector 400 has a structure where the diffraction grating is formed on the surface of the substrate. The diffraction grating has characteristics of reflecting the incident beam to diffraction beams of several orders.

FIG. 4A shows a diffraction beam when the incident beam is perpendicularly incident to the diffraction grating. The diffraction beam is reflected to diffraction beams having various reflected angles of −2 to +2 orders.

However, as shown in FIG. 4B, when the incident beam is incident to be inclined to the diffraction grating, the beam may be reflected as having only a single diffraction order (−1). In this case, in order to reflect the incident beam as having only the single diffraction order, the incident beam needs to satisfy conditions such as a period of a diffraction grating and an incident angle. Further, the pattern of the diffraction grating may be formed in various shapes such as a quadrangular shape, a triangular shape, and a circular shape, and the diffraction may be made due to a nano pattern.

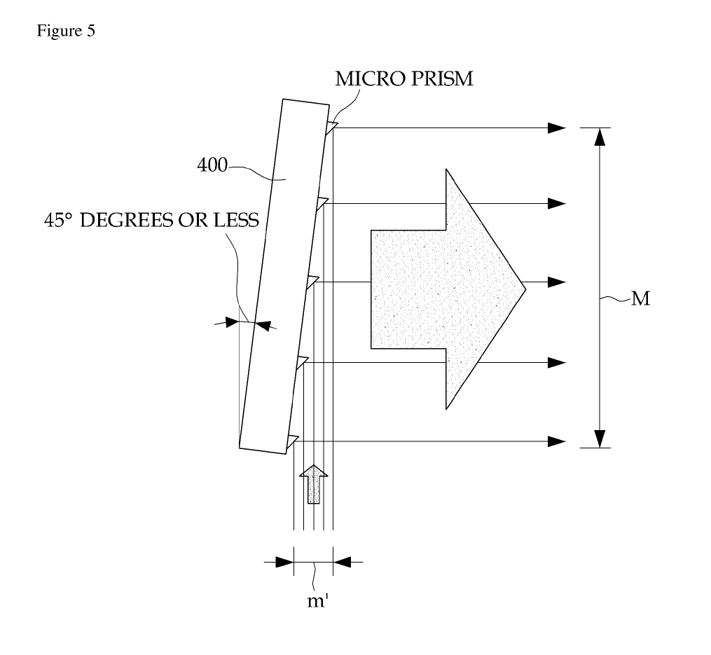

FIG. 5 is a diagram for explaining beam reflection characteristics of the beam deflector formed with a micro prism.

Referring to FIG. 5, beam deflector 400 has a structure in which a plurality of prisms having a size of several microns to several hundred microns is formed on the surface of the substrate. In this case, reflectivity may be increased by making a reflection coating on the surface of the prism. The beam reflector formed with the micro prism performs the same function as the beam deflector formed with the diffraction grating.

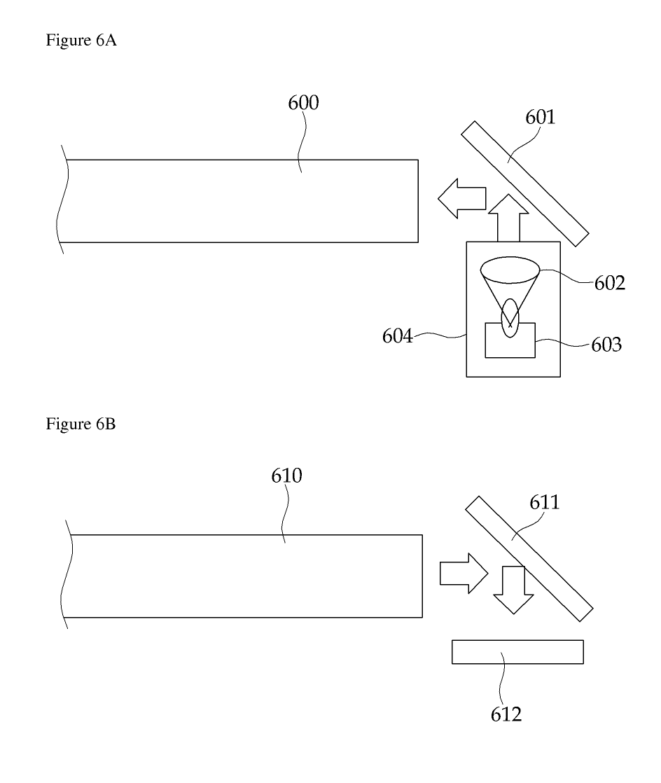

FIGS. 6A and 6B are diagrams for explaining a case in which the light source unit and the photodetector are perpendicularly positioned to the beam deflector.

Referring to FIG. 6A, when a light source unit 604 including a lens 602 and a light source 603 is not parallely disposed in the same axis direction (for example, a horizontal axis) as a first beam deflector 600 but is perpendicularly disposed to the first beam deflector 600 (for example, disposed in a vertical-axis direction), the touch screen panel may be implemented by reflecting the parallel light generated in a direction perpendicular to first beam deflector 600 through a mirror 601 inclined at 45 degrees, to input the parallel light in parallel to first beam deflector 600 in, for example, the horizontal-axis direction.

In this case, when mirror 601 is configured as a concave mirror, lens 602 may be omitted. The concave mirror serves to reflect the direction of light in a perpendicular direction while generating light from the light source 603 as parallel light.

In addition, referring to FIG. 6B, when a photodetector 612 is not disposed in parallel with a second beam deflector 610 disposed in, for example, the horizontal-axis direction but is perpendicularly disposed in the vertical-axis direction, the touch screen panel may be implemented by perpendicularly reflecting, through a mirror 611, the parallel light input in parallel in the horizontal-axis direction from second beam deflector 610, to perpendicularly input the reflected parallel light to photodetector 612 in the vertical-axis direction.

In this case, when mirror 611 is configured as a concave mirror, lens (not shown) may be omitted. The concave mirror serves to perpendicularly reflect the parallel light incident from second beam deflector 610, while collecting and inputting the parallel light to photodetector 612.

The structures of FIGS. 6A and 6B may be very useful for miniaturizing the volume of the touch screen panel as well as for an efficient block of noise.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An optical touch screen panel, comprising:
a light source unit configured to generate light parallel with a horizontal axis or a vertical axis of a touch screen;
a first beam deflector configured to increase a width of the parallel light parallel with the horizontal axis incident from the light source unit to be matched with a width of the horizontal-axis of the touch screen, or increase a width of the incident parallel light parallel with the vertical axis to be matched with a width of the vertical-axis of the touch screen in order to reflect the parallel light having the increased width;
a second beam deflector configured to reduce the width of parallel light incident from the first beam deflector in order to reflect the parallel light having the reduced width; and
a photodetector unit to sense a touched position of an object on the horizontal-axis or the vertical-axis of the touch screen through signal detection of the parallel light incident from the second beam deflector.

2. The optical touch screen panel of claim 1, wherein the light source unit includes at least one light source to generate light and at least one lens to generate the generated light as parallel light.

3. The optical touch screen panel of claim 1, wherein the first and second beam deflectors have a structure in which diffraction grating is formed or a micro prism is formed.

4. The optical touch screen panel of claim 1, wherein the photodetector unit is configured with at least one-dimensional or two-dimensional photodetector array.

5. The optical touch screen panel of claim 4, wherein the photodetector unit senses an expected touched position of an object close to the touch screen when the photodetector unit is configured with the two-dimensional photodetector array.

6. The optical touch screen panel of claim 1, further comprising a first mirror to reflect parallel light generated from the light source unit and parallely input the reflected parallel light to the first beam deflector when the light source unit is perpendicularly disposed to the first beam deflector.

7. The optical touch screen panel of claim 1, further comprising a second mirror to perpendicularly reflect the parallel light incident from the second beam deflector and to input the reflected parallel light to the photodetector unit when the photodetector unit is perpendicularly positioned to the second beam deflector.

8. The optical touch screen panel of claim 1, wherein the light source unit includes at least one light source to generate light and a concave mirror to perpendicularly reflect the light while generating the generated light as parallel light when the light source unit is perpendicularly positioned to the first beam deflector.

9. The optical touch screen panel of claim 7, wherein the second mirror is a concave mirror configured to perpendicularly reflect the parallel light incident from the second beam deflector while collecting the parallel light, thereby inputting the reflected light to the photodetector unit.

10. A method of detecting a position of an optical touch, comprising:
generating light parallel with a horizontal axis or a vertical axis of a touch screen;
first reflecting parallel light to increase a width of the parallel light parallel with the horizontal axis to be matched with a width of the horizontal-axis of the touch screen, or increase a width of the parallel light parallel with the vertical axis to be matched with a width of the vertical-axis of the touch screen in order to reflect the parallel light having the increased width;
second reflecting parallel light to reduce the width of reflected parallel light in order to reflect the parallel light having the reduced width; and
sensing a touched position of an object on the horizontal-axis or the vertical-axis of the touch screen by detecting the signal of the reflected parallel light at the second reflecting parallel light.
